(19) United States
(12) Patent Application Publication
(10) Pub. No.: US 2003/0069970 A1
(43) Pub. Date: Apr. 10, 2003

(54) Method for controlling traffic flow using token bucket

(75) Inventors: Sung Hwan Kim, Daejeon (KR); Sung En Park, Daejeon (KR); Hyun Sook Kim, Daejeon (KR)

Correspondence Address: Bryan A. Santarelli, GRAYBEAL JACKSON HALEY LLP, Suite 350, 155-108th Avenue N.E., Bellevue, WA, 98004-5901, US

(73) Assignee: KT Corporation

(21) Appl. No.: 10/260,765

(22) Filed: Sep. 27, 2002

(30) Foreign Application Priority Data
Oct. 4, 2001 (KR) 2001-61182

(51) Int. Cl. G06F 15/173

(52) U.S. Cl. 709/225; 709/224

(57) ABSTRACT

The present invention relates to a method for controlling a traffic flow using a token bucket. The present invention provides a method for controlling a traffic flow using a token bucket provided for processing packets for each class of the traffic flow classified into a plurality of classes and having a tree structure. The token bucket comprises a control bucket, a merged bucket or a divided bucket. The method comprises the steps of monitoring the control bucket for each class of the traffic flow; checking whether an token overflow or packet drop occurs in the control bucket; transmitting overflowed tokens to the merged bucket of an upper order node when the overflow occurs in the control bucket, or transmitting dropped packets to the divided bucket when the packet drop occurs in the control bucket; determining whether an overflow occurs in the merged bucket of the upper order node or the divided bucket to which the overflowed tokens and dropped packets are transmitted; and when the merged bucket or the divided bucket is overflowed, merging or dividing a flow of a corresponding class.

### CROSS-REFERENCE To RELATED APPLICATIONS

The present application claims priority from Korean patent application no. 2001-61182, filed Oct. 4, 2001, presently pending.

### BACKGROUND OF THE INVENTION

1. Field of the Invention

The present invention relates to a technology for guaranteeing a Quality of Service (QoS) on a network, and more particularly, to a method for controlling a traffic flow using a token bucket by finding an abnormal traffic flow through monitoring of merged and divided buckets corresponding to token overflow or packet drop of the token bucket in which tokens are accumulated and by controlling dividing or merging of abnormal classes based on the conditions of the merged buckets and the divided buckets.

2. Description of the Prior Art

A great number of packets are transmitted to their destinations on networks. Routers, access points, gateways, etc. for designating routes of packets in the way of the transmission analyze the packets received therein and transmit the packets to network equipment or the like to be targeted.

At that time, the traffic flows classified into a plurality of classes are controlled to guarantee QoS. Technologies for guaranteeing such QoS include queue control, traffic shaping and the like.

However, in such conventional technologies, since the classes of the traffic flow were classified according to the preset traffic classification rule, if any class of the traffic flow is abnormally generated, control is conducted for not only the abnormal traffic flow but also a normal traffic flow classified into the same traffic flow as the abnormal traffic, which results in deterioration of network efficiency.

In order to overcome such a problem of deterioration of network efficiency, all traffic flows should be classified into different classes and respective control mechanisms should be applied to the relevant classified classes. However, this is impracticable since it is technically impossible to classify all traffic flows.

### SUMMARY OF THE INVENTION

The present invention is conceived to solve the problems in the prior art. An object of the present invention is to find abnormal traffic flow classes through monitoring of token overflow or packet drop of a token bucket of a traffic flow and perform merging or dividing control of classes by checking merging or dividing condition match only for traffic flows of the found abnormal traffic classes.

In order to accomplish the above object, the present invention provides a method for controlling a traffic flow using a token bucket provided for processing packets for each class of the traffic flow classified into a plurality of classes and having a tree structure. The token bucket comprises a control bucket, a merged bucket or a divided bucket. The method comprises the steps of monitoring the control bucket for each class of the traffic flow; checking whether an token overflow or packet drop occurs in the control bucket; transmitting overflowed tokens to the merged bucket of an upper order node when the overflow occurs in the control bucket, or transmitting dropped packets to the divided bucket when the packet drop occurs in the control bucket; determining whether an overflow occurs in the merged bucket of the upper order node or the divided bucket to which the overflowed tokens and dropped packets are transmitted; and when the merged bucket or the divided bucket is overflowed, merging or dividing a flow of a corresponding class.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flowchart illustrating a general operation in a traffic flow control method using a token bucket according to an embodiment of the present invention;

FIG. 2 is a view showing a configuration of token buckets for traffic flow control using the token buckets according to the embodiment of the present invention;

FIG. 3 is a view showing dividing and merging of traffic flows according to the embodiment of the present invention;

FIG. 4 is a view showing a configuration of token buckets for traffic flows using the token buckets according to an embodiment of the present invention;

FIG. 5 is a flowchart illustrating a procedure of processing tokens in the traffic flow control method using the token buckets according to the embodiment of the present invention; and

FIG. 6 is a flowchart illustrating a procedure of processing packets in the traffic flow control method using the token buckets according to the embodiment of the present invention.

### DETAILED DESCRIPTION OF THE PREFERRED EMBODIMENT

Hereinafter, a preferred embodiment of the present invention, which those skilled in the art can easily work, will be described in detail with reference to the accompanying drawings.

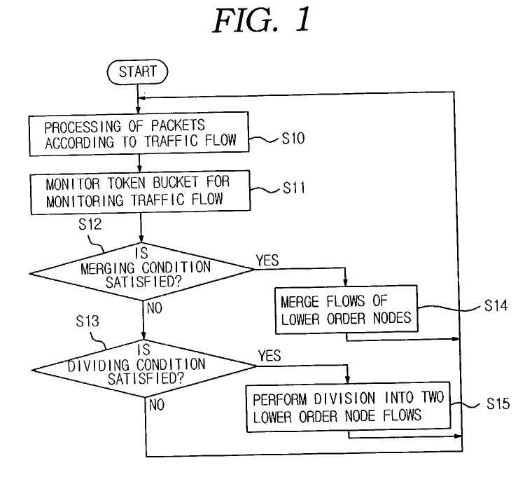

FIG. 1 is a flowchart illustrating a general operation in a traffic flow control method using a token bucket according to an embodiment of the present invention. As shown in FIG. 1, when packets are applied to a traffic flow processing apparatus such as a router, a gateway, an access point, etc., to which the present invention is applicable, the packets are transmitted or dropped according to the token bucket state (S10). Under this state, in the traffic flow control method using the token bucket according to an embodiment of the present invention, a token bucket for each node (i.e., for each class) of the traffic flow is monitored so as to monitor the traffic flow (S11), and then, as a result of monitoring, it is determined whether an token overflow or packet drop is generated in the token bucket and a merging or dividing condition is satisfied (S12, S13). When it is determined in the determination step (S12) that the merging condition is satisfied, traffic flows corresponding to one lower order node of the corresponding node are merged (S14). When it is determined in the determination step (S13) that the dividing condition is satisfied, the corresponding node is divided to form flows of two lower order nodes (S15). Here, the number of lower order nodes formed by the division is not limited to two but may be more than two.

Therefore, the traffic flows are divided when traffic rate is higher than token generating rate and the traffic flows are merged when the traffic rate is lower than the token generating rate. In other words, the traffic flows are controlled in accordance with the token bucket. The dividing of the traffic flows may prevent deterioration of network efficiency caused by traffic flows having abnormally high traffic rates. Also, according to the merging process, the traffic flows included in the same traffic flow class can share the same bandwidth and the number of the token bucket can be reduced. Thus, the efficiency of network is improved.

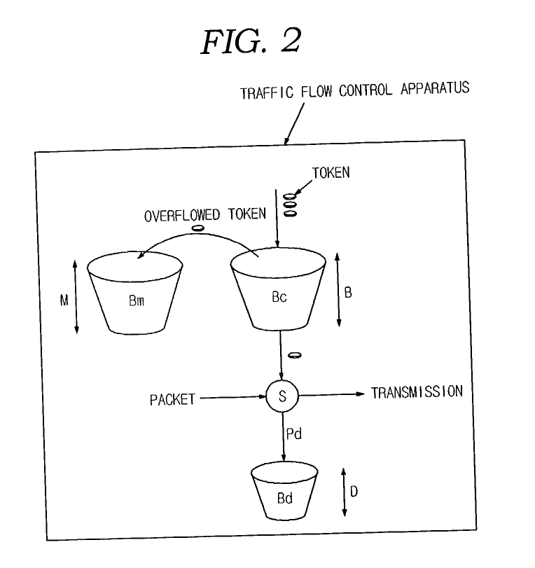

Now, a concept that is applicable to the traffic flow control method using the token bucket according to the embodiment of the present invention will be described with reference to FIG. 2.

First, terms used in FIG. 2 and herein will be defined. A mixer S is defined as a module (a program or a device with the program installed therein) for causing packets inputted thereto to correspond to tokens of a control bucket Bc and transmitting the corresponding packets to the outside, a filling size B is defined as the maximal number of tokens which can be accumulated in the control bucket, a merging size M is defined as the maximal number of tokens which can be accumulated in a merged bucket Bm, a dividing size D is defined as the maximal volume of packets which can be accumulated in a divided bucket Bd, and a drop packet Pd is defined as a packet not processed.

FIG. 2 is a view showing a configuration of token buckets for traffic flow control using the token buckets according to the embodiment of the present invention. As shown in FIG. 2, the token bucket of the present invention includes the control bucket Bc, the merged bucket Bm and the divided bucket Bd, which are located on respective nodes of the traffic flow, and processes packets in cooperation with the mixer S at which packets and tokens arrive.

In the above, each bucket Bc, Bm or Bd and the mixer S are software installed in the traffic flow control apparatus for performing the traffic flow control method of the present invention.

More particularly, the control bucket Bc receives tokens which arrive with a specific token arrival rate R and the tokens can be accumulated in the control bucket Bc up to the filling size B. The control bucket Bc processes the packets by consuming tokens by sizes of packets when the packets arrive at the mixer S. For example, if a size of packet is 5, 5 tokens are consumed, or if a size of packet is 10, 10 tokens are consumed.

At that time, the control bucket Bc has two different cases based on a relationship between the interval of time of packets arriving at the mixer S and the token arrival rate R. A first case is a case where the interval of time of the packets arriving at the mixer S is longer than that of the tokens arriving at the control bucket Bc. In this case, the tokens are increasingly accumulated in the control bucket Bc, resulting in overflow thereof. A second case is a case where the interval of time of the packets arriving at the mixer S is shorter than that of the tokens arriving at the control bucket Bc. In this case, since the tokens are not left in the control bucket Bc, the control bucket Bc cannot process packets arriving thereat.

In the meantime, the merged bucket Bm, which is activated when the first case occurs, receives overflowed tokens when the control bucket Bc is overflowed. At that time, the merged bucket Bm can receive the overflowed tokens by the merging size M.

The divided bucket Bd, which is activated when the second case occurs, receives and accumulates packets therein when the packets are dropped. The divided bucket Bd can receive the dropped packets Pd by the dividing size D.

Meanwhile, in the traffic flow control method of the present invention, an abnormality of the traffic flow and the merging or dividing of the traffic flow are monitored by monitoring the control bucket Bm, the merged bucket Bm and the divided bucket Bd. When an overflow occurs in the control bucket Bc or the control bucket Bc has no token, the traffic flow is determined as being abnormal, and when the merged bucket Bm or the divided bucket Bd is filled with tokens (i.e., when an overflow occurs), the merging or the division is conducted.

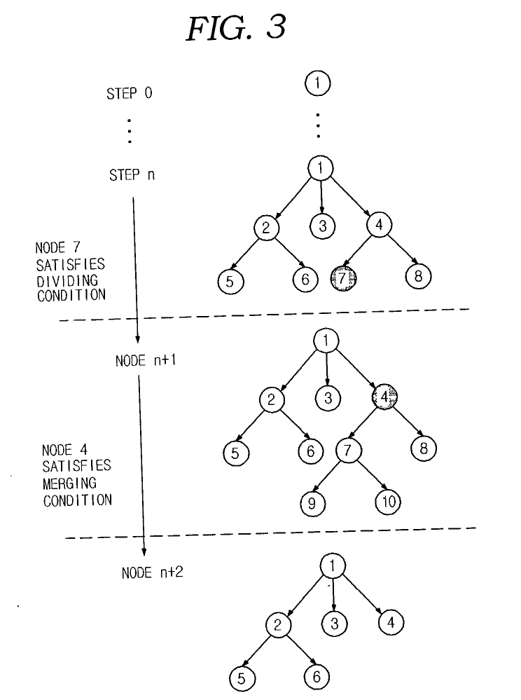

The merging or dividing of the traffic flow when the merging or dividing condition is satisfied is shown in FIG. 3. FIG. 3 is a view showing dividing and merging of traffic flows according to the embodiment of the present invention.

As shown in FIG. 3, a whole traffic flow control is performed with a tree structure in the present invention. The procedure of the control is as follows.

Step 0 represents a traffic flow of “1” having no control and step n represents a tree structure in which a plurality lower order nodes 2 to 8 are generated by dividing and merging the traffic flow of “1” through a plurality of controls, and it is shown that node 7 satisfies the dividing condition.

Accordingly, step n+1 represents that lower order nodes 9 and 10 are generated corresponding to the dividing condition of node 7, and it is shown that node 4 satisfies the merging condition.

As node 4 of step n+1 satisfies the merging condition, step n+2 represents that monitoring and control functions for lower order nodes 7, 9 and 10 branching from node 4 are released and the lower order nodes 7, 9 and 10 are merged into node 4.

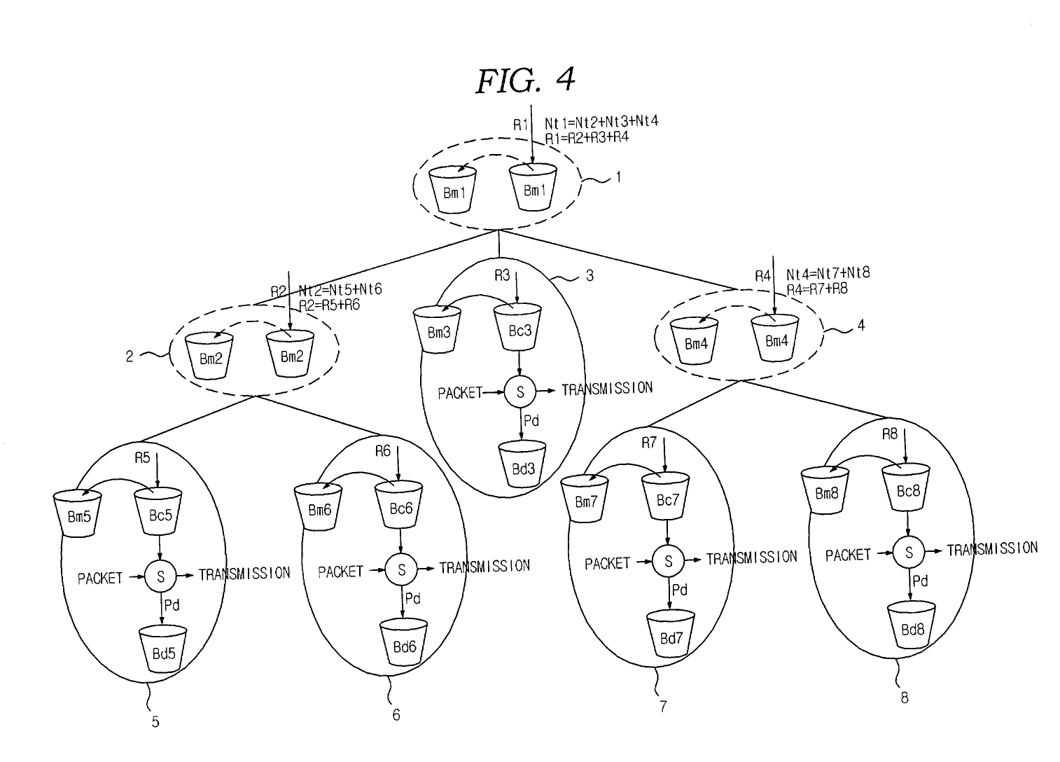

Now, the traffic flow control method using the token bucket according to the present invention will be described with reference to FIGS. 4, 5 and 6.

FIG. 4 is a view showing a configuration of token buckets for traffic flows using the token buckets according to an embodiment of the present invention, wherein the nodes, i.e., classes, of the traffic flow shown in FIG. 3 are shown by the configuration of the buckets.

As shown in FIG. 4, a traffic flow of a class is differently controlled depending on whether the class is an upper order node or a lower order node, and accordingly, the configuration of the token buckets is varied. In other words, since a class of an upper order node has a plurality of lower order nodes through division, merging of the class is controlled, and accordingly, a token bucket consists of the control bucket Bc and the merged bucket Bm. On the contrary, since a lower order node does not have its own lower order nodes, division of the lower order node into other lower order nodes together with merging thereof is controlled, and accordingly, a token bucket consists of the control bucket Bc, the merged bucket Bm and the divided bucket Bd.

Here, considering the upper order nodes in which only merging is controlled, it can be seen that each of upper order nodes 1, 2 and 4 does not have a function of the mixer S and so does not perform processing of a packet. This is because each of upper order nodes 1, 2 and 4 allots the function of the mixer S among lower order nodes while each of upper order nodes 1, 2 and 4 is divided. Therefore, overflowed tokens are not produced since packets are not processed in the upper order nodes, whereas overflowed tokens are produced in only the lower order nodes.

Therefore, in the present invention, the merging is accomplished when the number Nt of the overflowed tokens occurring in the lower order nodes exceeds merging bucket sizes of the upper order nodes. As an example, considering upper order node 2 and lower order nodes 5 and 6, it can be seen that the numbers Nt5 and Nt6 of the overflowed tokens occurring in lower order nodes 5 and 6 become equal to the number Nt2 (=Nt5+Nt6) of the overflowed tokens of upper order node 2 and the merging of the lower order nodes into the upper order node is accomplished when Nt2 is equal to or larger than the size M of the merged bucket Bm.

On the other hand, considering the lower order nodes at which the merging and the division are controlled, it can be seen that each of lower order nodes 3, 5, 6, 7 and 8 has the structure shown in FIG. 2 for processing, dividing and merging of packets. Each of lower order nodes 3, 5, 6, 7 and 8 has a token arrival rate smaller than a token arrival rate of the upper order node for processing packets instead of the upper order node and has a size of the merged bucket smaller than that of the upper order node.

For example, since lower order nodes 5 and 6 of node 2 having token arrival rates R5 and R6 respectively share the amount of packets processed by node 2, lower order nodes 5 and 6 share out the token arrival rate R2 of node 2. That is, R2=R5+R6.

According to the above description, the structure of the token bucket and the traffic flow control in each of nodes shown in FIG. 4 are as follows.

Since upper order node 1 has been already divided into a plurality of nodes 2, 3 and 4, further division does not occur and thus it is checked only whether merging should be performed.

In addition, in middle stage nodes 2, 3 and 4, nodes 2 and 4 are checked only for merging since they have lower order nodes like node 1, and node 3 is checked for both merging and division since it has no lower order node. Lowest order nodes 5, 6, 7 and 8 are checked for both merging and division since they do not have lower order nodes like node 3.

In the above, node 1, 2 and 4 in which only merging is checked are formed with only the control bucket Bc and the merged bucket Bm, and nodes 3, 5, 6, 7 and 8 in which both merging and division are checked have the same configuration as shown in FIG. 2.

Here, the control bucket Bc formed in each node has the filling size B set differently for each kind of class. Namely, each node shown in FIG. 4 is classified into a plurality of different classes, and only an identical kind of classes has an identical filling size. In addition, a size of the divided bucket or the merged bucket for each class is thus different from one another by each class.

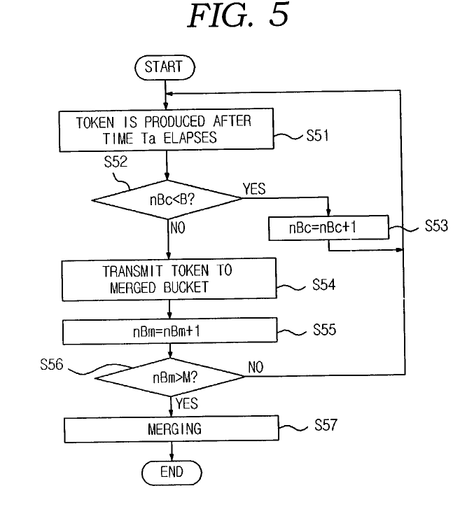

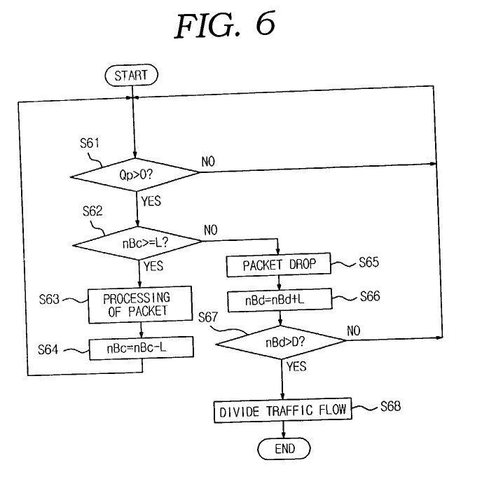

Now, the above description will be further explained with reference to FIGS. 5 and 6.

First, a procedure of processing tokens (also referred to as a procedure of the merging process) will be explained with reference to FIG. 5 by applying it to nodes 5 and 6 of FIG. 4. FIG. 5 is a flowchart illustrating a procedure of processing the tokens in the traffic flow control method using the token buckets according to the embodiment of the present invention.

As shown in FIG. 5, when token arrival time Ta (a reciprocal of arrival rate R) elapses, a token is produced, i.e., arrives from the outside (S51). The token which has arrived thereat is accumulated in the control bucket Bc. The control bucket Bc checks whether an overflow occurs or not. At that time, the check is accomplished by determining whether the number nBc of tokens accumulated in the control bucket Bc is equal to or larger than a preset filling size B (S52).

If it is determined in the determination step S52 that the overflow does not occur, the control bucket Bc receives one token and so the number nBc of token is increased by one (S53). If it is determined in the determination step S52 that the overflow occurs, the overflowed token is accumulated in the merged bucket Bm and so the number nBm of tokens is increased by one (S54 and S55).

In the above, when the number nBm of tokens in the merged bucket Bm is increased, it is determined whether an overflow occurs by checking whether the number nBm of tokens accumulated in the merged bucket Bm is larger than merging size M or not (S56). If it is determined in this determination step S56 that an overflow does not occur, the traffic flow control is not performed. Otherwise, lower order nodes are removed, that is, lower order nodes are merged into their upper node (S57).

Now, a procedure of processing the packets (also referred to as a procedure of the dividing process) will be explained with reference to FIG. 6. FIG. 6 is a flowchart illustrating a procedure of processing packets in the traffic flow control method using the token buckets according to the embodiment of the present invention.

As shown in FIG. 6, when the number Qp of packet to be processed is left in the mixer S or arrives at the mixer S (S61), it is confirmed as to whether tokens for processing packets are left in the control bucket Bc (S62). Here, assuming that a size of packet to be processed is L, it is confirmed as to whether the number nBc of tokens in the control bucket Bc is equal to or larger than L.

If it is confirmed in the confirmation step S62 that tokens for processing packets are left in the control bucket Bc, the tokens are consumed to process the packets (S63). Then, the number nBc of tokens in the control bucket Bc is decreased by the number of tokens consumed for processing the packets (i.e., the number of tokens equal to the size of the processed packets) (S64).

However, if it is confirmed in the confirmation step S62 that tokens for processing packets are not left in the control bucket Bc, the packets are not processed, i.e. become drop packets Pd (S65). In addition, the drop packets Pb is transmitted to and accumulated in the divided bucket Bd and the amount nBd of drop packets in the divided bucket Bd is increased by the size of packet L (S66).

Thus, when the drop packets Pd are produced, it is checked whether an overflow occurs in the divided bucket Bd. This check is accomplished by determining whether the amount nBd of drop packets accumulated in the divided bucket Bd is larger than dividing size D or not (S67).

If it is checked in the check step S67 that an overflow does not occur in the divided bucket Bd, the procedure returns to the step S61 for processing the packets. Otherwise, traffic flow division for forming two lower order nodes on a node at which the overflow occurs is performed (S68).

Thus, according to the description made with reference to FIGS. 5 and 6, control of the dividing and merging of the traffic flow shown in FIG. 3 is performed.

The dividing and merging of nodes of the traffic flow described above are to improve inefficient traffic occurring when packets arrive at a specific node (a specific traffic flow) to an extent which cannot be processed or packets do not arrive thereat during a very long period of time.

Here, the sum of token arrival rates at each node except an upper order node is set to become equal to a token arrival rate at the upper order node. Namely, if one node is divided into two lower order nodes, the sum of token arrival rates at the two lower order nodes is set to become equal to a token arrival rate at the upper order node just above them.

In the above description, one node means one class and a lower order node of one class means all classes branching from the one class.

As described above, the present invention improves network efficiency by performing division control for an abnormal traffic flow when the traffic is congested and merging control for the abnormal traffic when the traffic is dull.

Although the technical spirit of the present invention has been described in connection with the accompanying drawings, the description is to describe a preferred embodiment of the present invention by way of example and does not limit the present invention thereto. It will be apparent to those skilled in the art that various modifications and changes can be made thereto without departing from the scope and spirit of the invention defined by the appended claims.

What is claimed is:

1. A method for controlling a traffic flow using a token bucket provided for processing packets for each class of the traffic flow classified into a plurality of classes and having a tree structure,
wherein the token bucket comprises a control bucket at which tokens arrive with a token arrival rate, a merged bucket receiving overflowed tokens from the control bucket or a divided bucket receiving dropped packets,
comprising:
a first step of monitoring the control bucket for each class of the traffic flow;
a second step of checking whether an overflow or packet drop occurs in the control bucket;
a third step of transmitting the overflowed tokens to the merged bucket of an upper order node when it is checked in the second step that the overflow occurs in the control bucket, or transmitting the dropped packets to the divided bucket when it is checked in the second step that the packet drop occurs in the control bucket;
a fourth step of determining whether an overflow occurs in the merged bucket of the upper order node or the divided bucket; and
a fifth step of when it is determined in the fourth step that the merged bucket of the upper order node or the divided bucket is overflowed, merging or dividing a flow of a relevant class.

2. The method as claimed in claim 1, wherein it is determined that the overflow occurs in the token bucket if the number of tokens accumulated in the token bucket is larger than a preset size of the token bucket.

3. The method as claimed in claim 2, wherein the token bucket is set to have different sizes according to the kinds of respective classes.

4. The method as claimed in claim 1, wherein, when the merged bucket is overflowed, a node corresponding to the overflowed merged bucket and a lower order node of the corresponding node are merged.

5. The method as claimed in claim 1, wherein, when the divided bucket is overflowed, the flow division of the corresponding class is accomplished by forming two lower order nodes in the class corresponding to the overflowed divided bucket.

6. The method as claimed in claim 1, wherein the token arrival rate of the relevant class is set to become equal to the sum of token arrival rates of lower order classes branching from the relevant class.
